(19) United States
(12) Patent Application Publication
(10) Pub. No.: US 2015/0227023 A1
(43) Pub. Date: Aug. 13, 2015

(54) FOCUS CONTROL APPARATUS AND CONTROL METHOD THEREFOR

(71) Applicant: CANON KABUSHIKI KAISHA, Tokyo (JP)

(72) Inventor: Hideyuki Hamano, Kawasaki-shi (JP)

(21) Appl. No.: 14/619,765

(22) Filed: Feb. 11, 2015

(30) Foreign Application Priority Data
Feb. 13, 2014 (JP) 2014-025925
Feb. 17, 2014 (JP) 2014-027862

(51) Int. Cl. G03B 13/36; H04N 5/232; H04N 5/14; H04N 5/335

(52) U.S. Cl. CPC G03B 13/36; H04N 5/335; H04N 5/23212; H04N 5/144; H04N 2209/048

(57) ABSTRACT

A focus control apparatus comprises: a setting unit configured to set a focus detection area in an area where a subject exists based on an image signal output from an image sensor that detects a light flux which enters via an imaging optical system; a first subject following unit configured to follow the subject by performing subject detection; a second subject following unit configured to follow the subject based on a contrast evaluation value generated from the image signal output from the image sensor; and a control unit configured to control a frame rate for following the subject by the second subject following unit to be faster than that by the first subject following unit.

### BACKGROUND OF THE INVENTION

1. Field of the Invention

The present invention relates to a focus control apparatus which performs focus detection using an image signal obtained by an image sensor that photoelectrically converts an image of a subject formed by an imaging optical system, and control method therefor.

2. Description of the Related Art

Conventionally, digital cameras and video cameras widely adopt a contrast detection type auto focusing (AF) method in which a subject is brought into focus by detecting a signal corresponding to a contrast evaluation values of the subject using an output signal from an image sensor, such as a CCD and CMOS sensor. In this method, the contrast evaluation values of the subject are sequentially detected while moving a focus lens along an optical axis within a predetermined moving range (AF scan), and then a focus lens point at which the contrast evaluation value is maximized is detected as an in-focus position.

On the other hand, image capturing apparatuses that calculate a moving amount of a subject using a characteristic amount of an signal within an image capturing area output from an image sensor, set a focus detection area based on the obtained moving amount, and perform focus control for the focus detection area are known. These image capturing apparatuses are capable of performing focus control while reducing effects of movement of the subject and camera shake at the time of image capturing operation.

Japanese Patent Laid-Open No. 4-340874 discloses a method in which integrated values of luminance signals within the focus detection area are calculated in the horizontal and vertical directions, the focus detection area is set by using the integrated values as characteristic values, and then the focus detection area is moved so as to follow the movement of a subject. With this method, it is possible to set the focus detection area more precisely.

However, a method for detecting the position of the subject disclosed in Japanese Patent Laid-Open No. 4-340874 has the following problem. Namely, in the method that detects a moving amount of the subject by taking the integrated value of the luminance signal of each row or column as a characteristic value as disclosed in Japanese Patent Laid-Open No. 4-340874, it is sometimes not possible to perform accurate detection because the integrated value affects a signal representing the subject as if it undergoes low-pass filtering.

Meanwhile, a moving amount of a subject may be detected by taking a peak signal of a luminance signal of each row or column as a characteristic value. However, in the case of using the peak signal of the luminance signal, if saturation occurs or the variation in peaks of the luminance signal within an area is small, accuracy of moving amount detection of the subject deteriorates.

Further, Japanese Patent Laid-Open No. 2010-96964 discloses a method of moving a focus detection area so as to follow a subject by combining face detection processing and pattern matching processing. With this method, it is possible to set the focus detection area more precisely. Further, as disclosed in Japanese Patent Laid-Open No. 2010-96964, subject detection accuracy can be improved via a method of detecting an absolute position of the subject, such as the face detection processing, and a method of detecting relative movement amount of the subject, such as the pattern matching. Meanwhile, it is also effective to shorten a detection interval and perform subject detection as many times as possible in unit time for improving subject detection accuracy with respect to the subject whose situation changes every moment.

Japanese Patent Laid-Open No. 2013-25107 discloses to increase the frequency for obtaining an output waveform of photoelectric converters, namely to change the frame rate to a higher frame rate during focus detection processing in a contrast detection type focus detection method using an imaging surface. As disclosed in Japanese Patent Laid-Open No. 2013-25107, by performing subject detection in addition to focus detection performed at a high frame rate, it is possible to perform focus detection more accurately.

However, there is a following problem for applying a method of detecting a subject position disclosed in Japanese Patent Laid-Open No. 2010-96964 to a method of changing frame rates before and after focus detection disclosed in Japanese Patent Laid-Open No. 2013-25107.

Namely, the method of detecting the absolute position of the subject (face detection processing, etc.) disclosed in Japanese Patent Laid-Open No. 2010-96964 requires a heavy operating load and thus requires time for it, it is difficult to update the detection result of the subject position in synchronization with the high frame rate.

On the other hand, in a method of detecting the relative moving amount of the subject such as pattern matching processing, it is possible to reduce a computation load by narrowing a calculation range for detecting the moving amount. However, in this method, the relative moving amount is detected from two sequential signals; therefore, if the time interval between the two signals are long, the possibility that a picture pattern changes increases, which causes deterioration of pattern (picture pattern) detection (matching) accuracy. Further, if the time interval between the two signals is long, it is necessary to broaden the calculation range for detecting the moving amount, which increases the computation load. With these reasons, in a case where the frame rate is low before the focus detection processing as disclosed in Japanese Patent Laid-Open No. 2013-25107, the subject detection accuracy deteriorates.

As described above, a subject detection method has a characteristic that relates to an updating interval of the detection result. However, Japanese Patent Laid-Open No. 2010-96964 does not disclose any suitable subject detection method when the frame rate changes.

### SUMMARY OF THE INVENTION

The present invention has been made in consideration of the above situation, and performs focusing processing with high precision that is not affected by the movement of a subject during the focusing processing without a large computation load.

Further, the present invention performs position detection of a subject within a frame with high precision regardless of the frame rate.

According to the present invention, provided is a focus control apparatus comprising: a setting unit configured to set a focus detection area in an area where a subject exists based on an image signal output from an image sensor that detects a light flux which enters via an imaging optical system; a first subject following unit configured to follow the subject by performing subject detection; a second subject following unit configured to follow the subject based on a contrast evaluation value generated from the image signal output from the image sensor; and a control unit configured to control a frame rate for following the subject by the second subject following unit to be faster than that by the first subject following unit.

Further, according to the present invention, provided is a focus control apparatus comprising: a setting unit configured to set a focus detection area in an area where a subject exists based on an image signal output from an image sensor that detects a light flux which enters via an imaging optical system; a subject following unit configured to follow the subject based on a contrast evaluation value generated from the image signal output from the image sensor; and a calculation unit configured to calculate information on a moving amount of the subject acquired by calculating correlation between two contrast evaluation values generated from two image signals output from the same focus detection area of the image sensor at different timings.

Furthermore, according to the present invention, provided is a control method for a focus control apparatus comprising: a setting step of setting a focus detection area in an area where a subject exists based on an image signal output from an image sensor that detects a light flux which enters via an imaging optical system; a first subject following step of following the subject by performing subject detection; a second subject following step of following the subject based on a contrast evaluation value generated from the image signal output from the image sensor; and a control step of controlling a frame rate for following the subject by the second subject following unit to be faster than that by the first subject following unit.

Further, according to the present invention, provided is a control method for a focus control apparatus comprising: a setting step of setting a focus detection area in an area where a subject exists based on an image signal output from an image sensor that detects a light flux which enters via an imaging optical system; a subject following step of following the subject based on a contrast evaluation value generated from the image signal output from the image sensor; and a calculation step of calculating information on a moving amount of the subject acquired by calculating correlation between two contrast evaluation values generated from two image signals output from the same focus detection area of the image sensor at different timings.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a brief configuration of an image capturing apparatus having a focus adjustment apparatus according to an embodiment of the present invention;

FIG. 2 is a block diagram illustrating a configuration of a scan AF processing circuit and a relationship with a CPU in a processing according to first and second embodiments;

FIG. 3 is a flowchart showing an AF operation procedure according to the first embodiment;

FIGS. 4A and 4B are diagrams showing setting of focus detection areas (AF evaluation ranges) according to the first and second embodiments;

FIG. 5 is a flowchart showing focus detection area setting processing according to the first and second embodiments;

FIG. 6 is a flowchart showing processing of relative moving amount acquisition and focus detection area setting according to the first and second embodiments;

FIG. 7 is a diagram showing an example of line-peak evaluation values according to the first and second embodiments;

FIG. 8 is a diagram illustrating timing for obtaining position information of a subject and timing of obtaining relative moving amounts of the subject according to the first and second embodiments;

FIG. 9 is a diagram illustrating timing of obtaining position information of a subject and timing of obtaining relative moving amounts of the subject according to a modification; and

FIG. 10 is a flowchart showing an AF operation procedure according to the second embodiment.

### DESCRIPTION OF THE EMBODIMENTS

Exemplary embodiments of the present invention will be described in detail in accordance with the accompanying drawings.

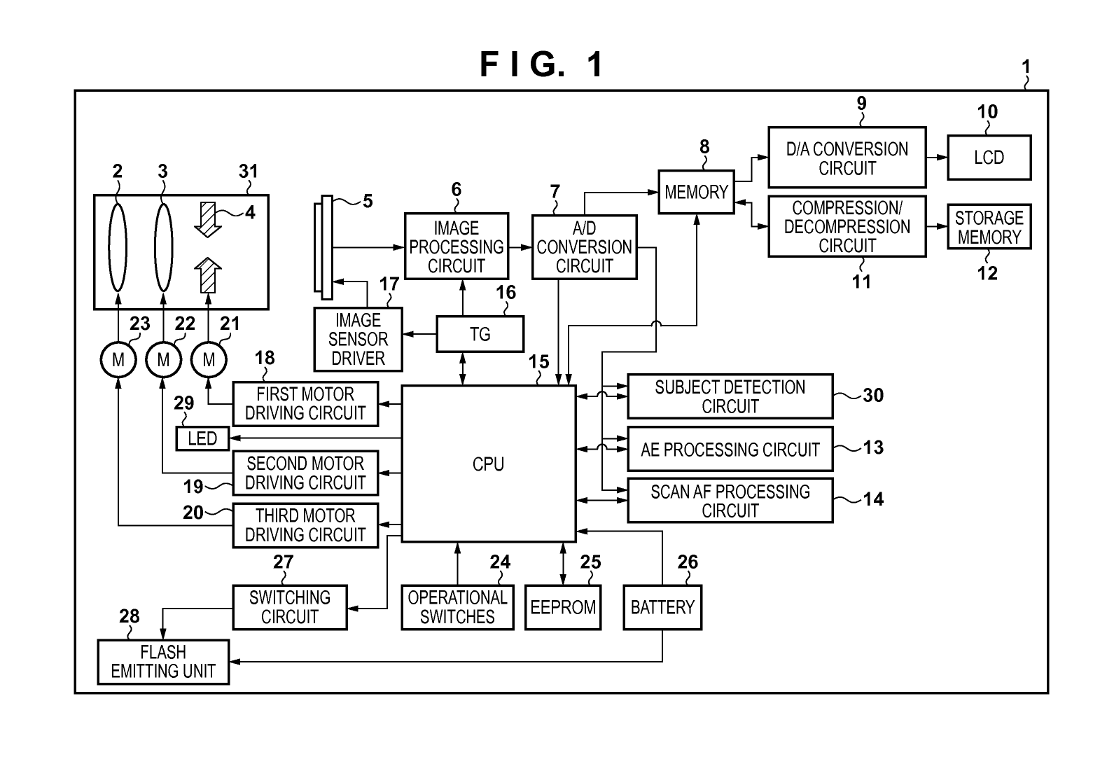

FIG. 1 is a block diagram illustrating a schematic configuration of an image capturing apparatus according to a first embodiment of the present invention. The image capturing apparatus includes a digital still camera and a digital video camera, for example. However, the present invention is not limited to these, and is applicable to apparatuses that obtain electrical images by photoelectrically converting incoming optical images using a two-dimensional image sensor, such as an area sensor.

In FIG. 1, reference numeral 1 denotes the image capturing apparatus, which may be a digital still camera or a digital video camera. A zoom lens group 2 and a focus lens group 3 for controlling a focus state of a subject image are included in an imaging optical system. An aperture 4 controls the amount of light flux that passes through the imaging optical system. The zoom lens group 2, focus lens group 3 and aperture 4 are arranged in a lens barrel 31.

An image sensor 5 is a sensor, such as a CCD, a CMOS sensor, and so forth, in which a plurality of pixels are arranged in two dimensions, and photoelectrically converts a subject image formed on the image sensor 5 by the imaging optical system. An image processing circuit 6 receives the electrical signal converted by the image sensor 5 and performs a variety of image processing thereon, thereby generating an image signal in a predetermined format. An A/D conversion circuit 7 converts an analog image signal generated by the image processing circuit 6 into a digital image signal.

A memory 8 is a buffer memory or the like, configured with VRAM, for example, which temporarily stores the digital image signal output from the A/D conversion circuit 7. Focus detection is performed by reading out from the memory 8 an image signal output from predetermined part of an imaging area of the image sensor 5 out of a digital image signal stored in the memory 8, and outputting the read image signal to a scan AF processing circuit 14, which will be explained later, via a CPU 15.

A D/A conversion circuit 9 reads out the image signal stored in the memory 8 and converts that data into an analog image signal, and further converts the analog data into an image signal in a format suited to display. An image display device 10 is a liquid-crystal display (LCD), for example, which displays the image signal converted by the D/A conversion circuit 9. A compression/decompression circuit 11 reads out the image signal temporarily stored in the memory 8 and performs a compression process, an encoding process, and the like, thereon, in order to convert the image data into an image signal in a format suited to storage in a storage memory 12. The storage memory 12 stores the image data processed by the compression/decompression circuit 11. Further, the compression/decompression circuit 11 reads out the image signal stored in the storage memory 12, performs a decompression process, a decoding process, and the like, thereon, in order to convert the image data into a format suited to playback or the like.

A variety of types of memories may be used as the storage memory 12; a semiconductor memory such as a flash memory, or the like that has a card or stick shape and can be removed from the image capturing apparatus 1, and magnetic storage media including hard disks, flexible disks, or the like, may be employed as the storage memory 12.

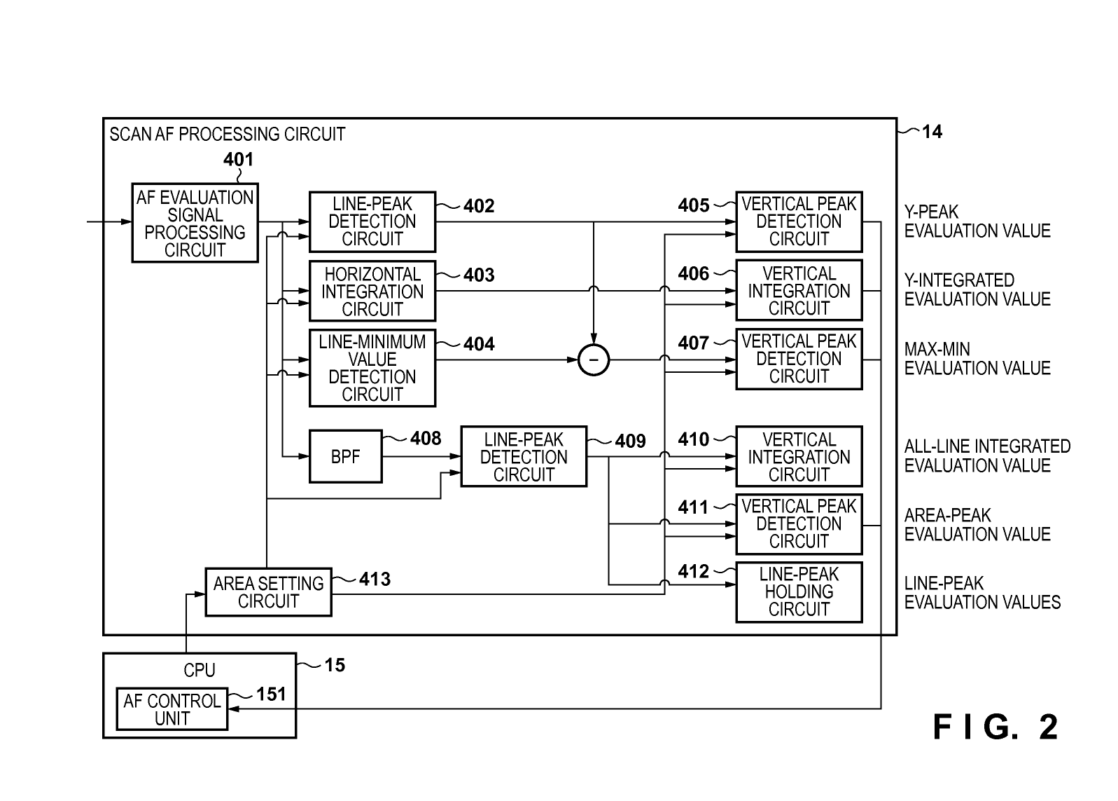

An AE processing circuit 13 carries out automatic exposure (AE) processing based on the image signal output from the A/D conversion circuit 7. The scan AF processing circuit 14 carries out automatic focus adjustment (AF) processing based on the image signal output from the A/D conversion circuit 7. The scan AF processing circuit 14 extracts predetermined frequency components from the image signal output from a predetermined partial area (focus detection area) of the imaging area of the image sensor 5, and calculates a focus evaluation value that represents a focus state. Further, the scan AF processing circuit 14 calculates various evaluation values to be used in a calculation for finding an in-focus position. These evaluation values will be described later in detail with reference to FIG. 2.

The CPU 15 controls each constituent element of the image capturing apparatus 1, and has a memory for operation. The CPU 15 calculates an in-focus position using the various evaluation values calculated by the scan AF processing circuit 14. The timing generator (TG) 16 generates a predetermined timing signal. An image sensor driver 17 drives the image sensor 5 based on the timing signal supplied from the TG 16.

A first motor driving circuit 18 drives the aperture 4 by driving an aperture driving motor 21 under the control of the CPU 15. A second motor driving circuit 19 drives the focus lens group 3 by driving a focus driving motor 22 on the basis of a focus evaluation value calculated by the scan AF processing circuit 14 under the control of the CPU 15. A third motor driving circuit 20 drives the zoom lens group 2 by driving a zoom driving motor 23 under the control of the CPU 15.

Operational switches 24 are configured of various types of switches, and include, for example, a main power switch, a release switch for starting shooting operations (storage operations) and the like, a playback switch, a zoom switch, switch for turning ON/OFF the display of an AF evaluation signal on a monitor, and so forth. The main power switch starts the image capturing apparatus 1 and supplying power thereto. The release switch is configured of a two-stage switch that has a first stroke (referred to as “SW1” hereinafter) for generating an instruction signal to start preparation for image sensing, such as AE and AF processing, performed prior to image capturing operation, and a second stroke (referred to as “SW2” hereinafter) for generating an instruction signal to start actual exposure operation. The playback switch starts playback operations, and the zoom switch instructs to move the zoom lens group 2 to perform zooming.

An EEPROM 25 is a read-only memory that can be electrically rewritten, and stores, in advance, programs for carrying out various types of control, data used to perform various types of operations, and so on. Reference numeral 26 indicates a battery; 28, a flash emitting unit; 27, a switching circuit that controls the emission of flash light by the flash emitting unit 28; 29, a display element, such as an LED, used for displaying OK/NG of the AF operation.

A subject detection circuit 30 performs face detection from an object field using the image data output from the A/D conversion circuit 7, and outputs one or more face information (position, size, reliability, direction of the face, the number of the face/faces) to the CPU 15. As the face detection method is not directly related to the present invention, therefore, the detailed explanation of it is omitted.

Next, the various evaluation values for AF processing calculated by the CPU 15 and the scan AF processing circuit 14 will be explained with reference to FIG. 2. FIG. 2 is a block diagram showing a configuration of the scan AF processing circuit 14 and a relationship with the CPU 15 in the processing.

When a digital signal converted by the A/D conversion circuit 7 is input to the scan AF processing circuit 14, an AF evaluation signal processing circuit 401 converts the digital signal into a luminance signal Y and performs gamma correction process of enhancing a low luminance component and suppressing a high luminance component. Then, a Y-peak evaluation value, Y-integrated evaluation value, Max-Min evaluation value, all-line integrated evaluation value, area-peak evaluation value, and line-peak evaluation values are calculated based on the processed signal. Calculation methods of the respective evaluation value will be explained below.

First, the calculation method of the Y-peak evaluation value will be explained. The luminance signal Y that underwent the gamma correction by the AF evaluation signal processing circuit 401 is input to a line-peak detection circuit 402 where a line-peak value (Y-line peak value) is calculated for each horizontal line within an AF evaluation area set by an area setting circuit 413. The output of the line-peak detection circuit 402 is input to a vertical peak detection circuit 405 where peak hold in the vertical direction is performed within the AF evaluation area, thereby the Y-peak evaluation value is generated. The Y-peak evaluation value is useful for determining a high luminance subject and a low illuminance subject.

Note that the area setting circuit 413 can set a plurality of types of AF evaluation areas. The details of the AF evaluation areas and which type of the AF evaluation area is to be set will be described below.

Next, the calculation method of the Y-integrated evaluation value will be described. The luminance signal Y that underwent the gamma correction is input to a horizontal integration circuit 403, where an integrated value of the luminance signal Y is calculated for each horizontal line within the AF evaluation area. The output of the horizontal integration circuit 403 is input to a vertical integration circuit 406, where integration in the vertical direction is performed within the AF evaluation area, thereby the Y-integrated evaluation value is generated. Brightness of the image within the whole AF evaluation area can be determined from the Y-integrated evaluation value.

Next, the calculation method of the Max-Min evaluation value will be explained. The luminance signal Y that underwent the gamma correction is input to the line-peak detection circuit 402, where the Y-line peak value is calculated for each horizontal line within the AF evaluation area. Further, the luminance signal Y is also input to a line-minimum value detection circuit 404, where the minimum value of the luminance signal Y is detected for each horizontal line within the AF evaluation area. The detected Y-line peak value and the minimum value of the luminance signal Y of each horizontal line are input to a subtracter. The subtracter calculates

(Y-line peak value)−(minimum value)

and its difference is input to a vertical peak detection circuit 407. The vertical peak detection circuit 407 performs peak-hold in the vertical direction within the AF evaluation area, thereby the Max-Min evaluation value is generated. The Max-Min evaluation value is useful to determine low-contrast/high-contrast.

Next, the calculation method of the area-peak evaluation value will be explained. The luminance signal Y that underwent the gamma correction passes through a BPF 408, thereby a predetermined frequency component is extracted and a focus detection signal is generated. This focus detection signal is input to a line-peak detection circuit 409, where a line-peak value is detected for each horizontal line within the AF evaluation area. A vertical peak detection circuit 411 performs peak-hold on the detected line-peak values within the AF evaluation area, thereby the area-peak evaluation value is generated. As the area-peak evaluation value does not fluctuate so much even if a subject moves within the AF evaluation area, it is useful in determining to restart a process of searching an in-focus position when it is in the in-focus state.

Next, the calculation method of the all-line integrated evaluation value will be explained. Similarly to the area-peak evaluation value, the line-peak detection circuit 409 detects the line-peak value for each horizontal line within the AF evaluation area. Then, the line-peak values are input to a vertical integration circuit 410 where the line-peak values are integrated for all the horizontal lines within the AF evaluation area in the vertical direction, thereby the all-line integrated evaluation value is generated. The all-line integrated evaluation value of a high frequency component has a wide dynamic range and high sensitivity due to the effect of the integration, and it is useful as a main evaluation value in the AF processing for detecting the in-focus position. In the present invention, the all-line integrated evaluation value, which fluctuates depending on the defocus state and is used for the focus adjustment, is referred to as a focus evaluation value.

Next, the calculation method of the line-peak evaluation values will be explained. Similarly to the area-peak evaluation value, the line-peak detection circuit 409 detects the line-peak value for each horizontal line within the AF evaluation area. Then, the line-peak values are input to a line-peak holding circuit 412 where the line-peak values are held for all the horizontal lines within the AF evaluation area in the vertical direction, thereby the line-peak evaluation values are obtained. The line-peak evaluation values show a distribution of the peak value of a predetermined frequency component for each row within the AF evaluation area, and are used for detecting the change in the position of a subject in the vertical direction in the present invention.

It should be noted that, in order to detect a change in position information of the subject, it is conceivable to detect the change in the vertical direction using the integrated value of the luminance signal Y calculated for each row in the course of calculating the Y-integrated evaluation value. However, due to its nature, the integrated value of the luminance signal Y for each row may affect the subject information as if it is processed by a low-pass filter, and the detection with high precision may not be performed. Further, it is conceivable to obtain position information of the subject using the peak signal of the luminance signal Y of each row. However, detection accuracy may deteriorate in a case where any of the peak signals of the luminance signal Y saturates or fluctuation of luminous peak is small in the vertical direction.

By contrast, according to the first embodiment, since the peak values of the information of a predetermined frequency component of the respective rows are used as the line-peak evaluation values, it is possible to detect a feature amount of the subject for each row with high precision. Further, when the luminance signal Y is saturated, as the information is obtained from a contour at which luminance changes, it is possible to obtain information on the subject. Furthermore, in a case where fluctuation of the luminous peak in the vertical direction is small, if the shape of the contour at which luminance changes is changing, it is possible to obtain the information of the subject.

In the first embodiment, the peak values of the information of the predetermined frequency component of the respective rows are used as the line-peak evaluation values; however, integrated values of the information of the predetermined frequency component of the respective rows may be used instead. There is a fear that the integrated values may change with respect to the movement of the subject in the horizontal direction, however, it is possible to obtain information with a high S/N ratio.

According to the first embodiment, when performing AF evaluation in the horizontal direction, a change in position of a subject in the vertical direction is detected on the basis of the line-peak evaluation values, and then the focus detection area is updated. In other words, to update the focus detection area corresponds to updating an area for which line peak values are to be integrated when calculating the all-line integrated evaluation value described above.

Meanwhile, the all-line integrated evaluation value, or the focus evaluation value, corresponds to an integrated value of the line-peak evaluation values for a predetermined area, and the focus evaluation value is used for detecting an in-focus position. This means that the operation of detecting the moving amount of the subject by using the line-peak evaluation values directly uses feature amounts that form the focus evaluation value, which improves precision of moving amount detection of a subject and in-focus position detection. Further, since the line-peak evaluation values are configured by using the line-peak values obtained in the course of calculating the focus evaluation value, it is possible to detect the moving amount of the subject without largely increasing the computation load.

The area setting circuit 413 generates a gate signal for specifying the AF evaluation area for selecting a signal of pixels located at predetermined positions of a frame set by the CPU 15. The gate signal is input to the line-peak detection circuit 402, the horizontal integration circuit 403, the line-minimum value detection circuit 404, the line-peak detection circuit 409, the vertical integration circuits 406 and 410, and the vertical peak detection circuits 405, 407 and 411. The timing of inputting the luminance signal Y to each of the above circuits are controlled so that each focus evaluation value is generated from the luminance signal Y within the AF evaluation area. Further, the area setting circuit 413 can generate gate signals of a plurality of areas as AF evaluation areas, and it is possible to set the gate signal of one of the plurality of areas to each of the circuits, as will be described later in detail.

An AF control unit 151 in the CPU 15 takes the Y-peak evaluation value, the Y-integrated evaluation value, the Max-Min evaluation value, and the area-peak evaluation value, and controls the focus driving motor 22 via the second motor driving circuit 19, thereby moving the focus lens group 3 in the optical axis direction to perform AF control.

It should be noted that the various evaluation values for the AF processing are calculated only in the horizontal direction in the first embodiment, however, they may be calculated in either or both of the horizontal and vertical directions accordingly to the first embodiment.

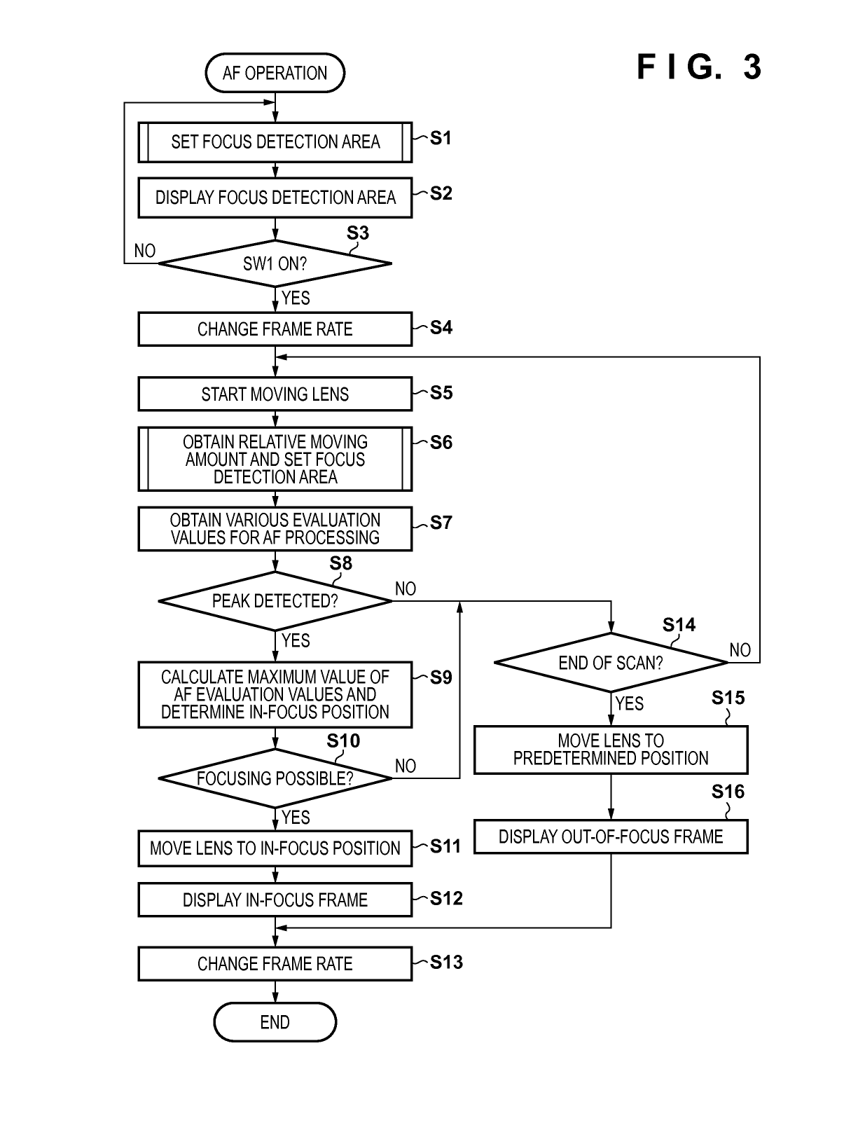

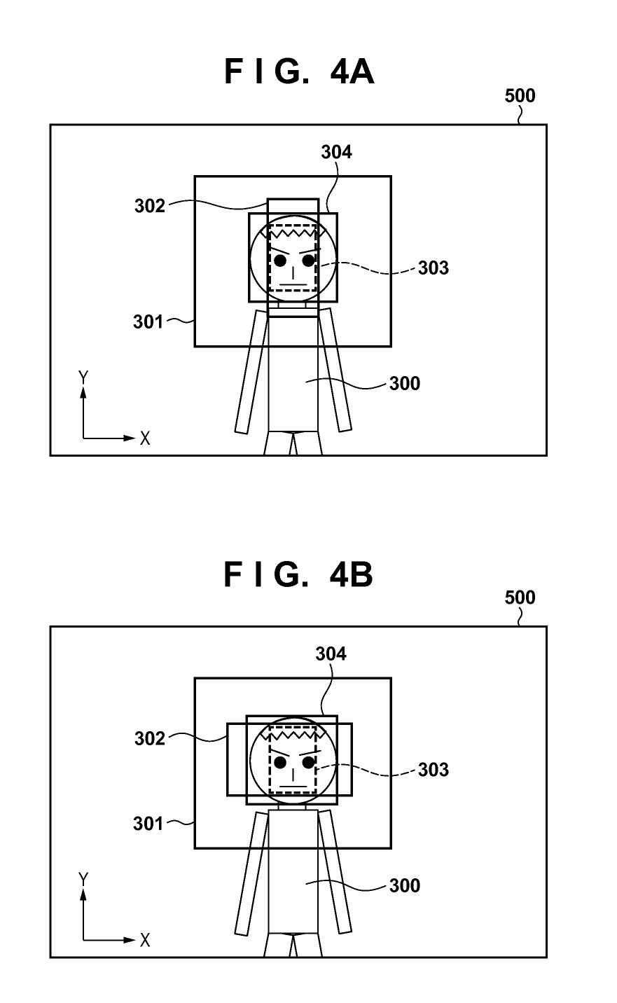

Next, the focusing processing (AF operation) using the subject detection in the electric camera according to the first embodiment will be described with reference to a flowchart showing the AF operation in FIG. 3, and FIGS. 4A and 4B.

In step S1, main subject detection is performed based on information (position, size, and the number of subjects) of a subject/subjects, such as human face/faces, obtained by the subject detection circuit 30, and the focus detection area is set. The focus detection area is set by the area setting circuit 413 in the scan AF processing circuit 14.

Here, the feature of the method for setting the focus detection areas according to the first embodiment will be explained with reference to FIGS. 4A and 4B. As shown in FIG. 4A, the focus detection areas are set within a detection area of a subject detected by the subject detection circuit 30 in a frame. An image frame 500 in FIG. 4A corresponds to a pixel area of the image sensor 5, and the scan AF processing circuit 14 calculates contrast information as the focus evaluation value, with the X direction in FIG. 4A being the AF evaluation direction.

A position information acquisition area 301 is set for a person 300 within the image frame 500 as an area for acquiring position information of the subject. In FIGS. 4A and 4B, the position information acquisition area 301 is smaller than the image frame 500, however, may be the same size as the image frame 500. FIGS. 4A and 4B shows an example, in a case where information on the position where the subject exists is known in advance, the area 301 is set by referring to the information.

Similarly, a moving amount information acquisition area 302, that is an area for acquiring relative moving amount information of the subject within a predetermined period of time, is set. The moving amount information acquisition area 302 is set so that the position information acquisition area 301 includes the moving amount information acquisition area 302. The moving amount information acquisition area 302 thus set is set to the line-peak detection circuit 409.

A subject detection area 304 is an area showing the position, size, and inclination of the subject detected within the position information acquisition area 301 by the subject detection circuit 30. A focus detection area 303 is set within the subject detection area 304. The reason for this is that if a contour portion of the subject exists within the focus detection area 303, focus detection is affected by a background image. However, if the subject is relatively small in the image, the focus detection area 303 may be set to the size equal to or greater than that of the subject detection area 304. How the information obtained from each area is used will be described later in detail. The focus detection area 303 thus set is set to circuits including the vertical integration circuit 410, except for the line-peak detection circuit 409 and the line-peak holding circuit 412.

In the first embodiment, as will be described later, the moving amount of the subject is detected using the line-peak evaluation values obtained within the moving amount information acquisition area 302. The direction of the moving amount detected at this time is the vertical direction. Since the focus detection area 303 is set using this moving amount, it is necessary to set the moving amount information acquisition area 302 so that unnecessary information in the horizontal direction is not included in the focus detection area 303. In the first embodiment, as described in FIG. 4A, the moving amount information acquisition area 302 is set so that its size in the X direction is substantially the same as that of the focus detection area 303. However, it is considered that the subject may move in the horizontal direction, the size in the X direction of the moving amount information acquisition area 302 with respect to the focus detection area 303 may be arbitrarily changed. For example, when it is detected that the subject moves greatly, the moving amount information acquisition area 302 may be set so that the size in the X direction is somewhat large.

FIG. 4B shows the moving amount information acquisition area 302 in a case where the Y direction in FIG. 4B is taken as the AF evaluation direction. For the reasons as set forth above, the moving amount information acquisition area 302 is set so that its size in the X direction is substantially equal to that of the focus detection area 303. Thus, the moving amount information acquisition area 302 may be changed in accordance with the AF evaluation direction. The details of the detection method of the subject moving amount will be described later.

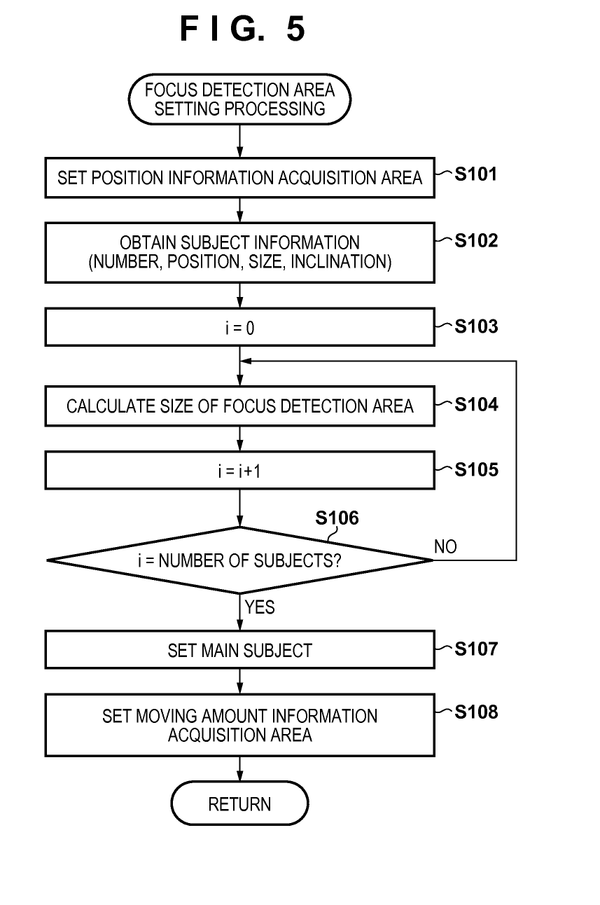

Further, the details of the process in step S1 will be described later with reference to FIG. 5. In step S2, the focus detection area 303 set in step S1 is displayed on the LCD 10 for notifying the user of it. The size, shape, and color of the focus detection area 303 are suitably set and displayed so that the focus detection area 303 is easily recognized by a photographer.

In step S3, on/off of the release switch SW1 for instructing to start the image capturing preparation including the focusing processing is detected. When it is not detected that the switch SW1 is turned on, the process returns to step S1 and the focus detection area is updated as appropriate. By contrast, when it is detected that the switch SW1 is turned on, the process proceeds to step S4 and the frame rate is changed. In order to perform the focusing processing at high speed, the operation of the image sensor 5 is switched so that the focus detection data can be obtained at a shorter time interval (second time interval) than a time interval (first time interval) at which the focus detection data is obtained before step S3. Accordingly, the live view on the LCD 10 is performed using image data obtained at the second time interval. However, the live view may be displayed at the second time interval or at the first time interval by thinning or adding image data.

Next, in step S5, the focus lens group 3 starts moving in the predetermined direction at the predetermined speed, and AF scan (focus detection processing) is performed. In the AF scan, the focus lens group 3 is moved from a scan start position to a scan end position by a predetermined amount while storing in the CPU 15 various evaluation values obtained from the scan AF processing circuit 14 at each focus lens position. The scan end position may be set to the end of the movable range of the focus lens group 3, for example. Alternatively, if it is determined that it will be focused in the vicinity of the current position of the focus lens group 3 based on the focusing results obtained in the past, the scan end position may be set to a position moved from the current position by a predetermined amount. The focus lens group 3 may be kept moved or may be stopped while acquiring the various evaluation values.

Next in step S6, a relative moving amount of the subject is acquired and the focus detection area 303 is set using the line-peak evaluation values output from the line-peak holding circuit 412 and obtained based on a signal output from the image sensor 5. In the first embodiment, after setting the focus detection area 303 using the position information of the subject before the switch SW1 is turned on, the relative moving amount of the subject is detected using the signals from the image sensor 5 obtained at different timing, and the focus detection area 303 is updated.

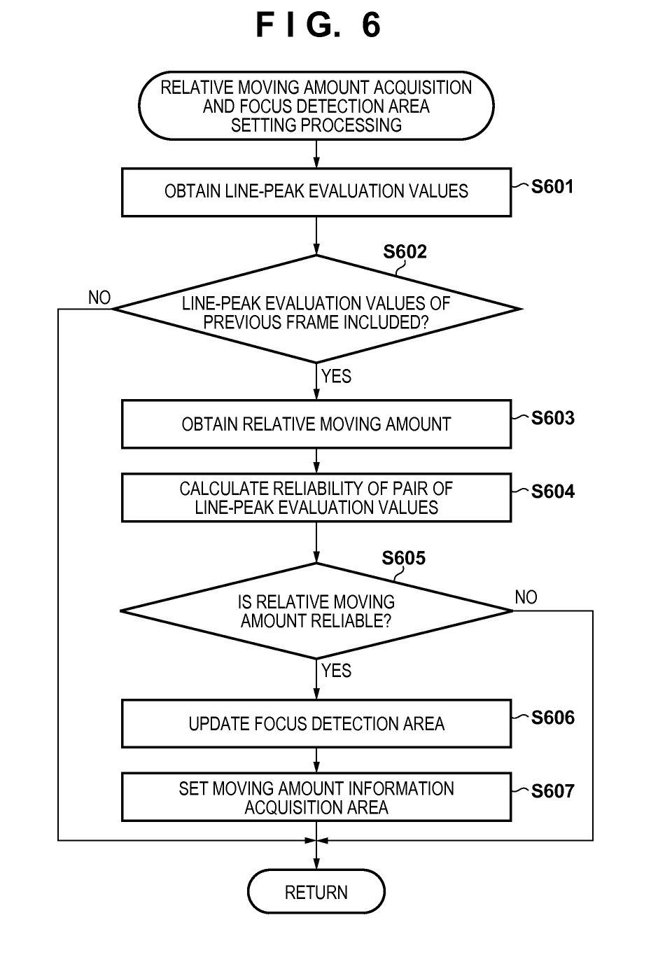

A computation amount for acquiring position information of the subject by face detection and two-dimensional pattern matching, for example, is large and time consuming. Meanwhile, when the frame rate is changed to a faster rate in order to accelerate focus adjustment speed, computation of the various evaluation values for AF processing is performed at a short time interval (second time interval). At that time, if the focus detection area 303 used in calculating the various evaluation values for AF processing is not updated and if the focus state detection is performed using the focus detection area 303 which is set based on the former position information of the subject, precision of the focus state detection may decrease due to an effect of an change in the position of the subject, camera shake, and so forth. Accordingly, in the first embodiment, in order to properly set the focus detection area 303, the relative moving amount of the subject is calculated after the frame rate is changed to a higher rate, and the focus detection area 303 is updated using the calculated relative moving amount. By doing so, it is possible to reduce an effect of the movement of the subject, camera shake, and so on, during the AF scan operation, thereby performing focus state detection at high precision. The details of the process performed in step S6 will be described later with reference to FIG. 6.

Next in step S7, the various evaluation values for AF processing as described above are calculated by the scan AF processing circuit 14, and the process proceeds to step S8. In step S8, whether or not the focus evaluation value is decreased by a predetermined amount or more from a previously obtained value is determined. If not, it is determined that a peak (maximum value) of the focus evaluation values is not detected, and the process proceeds to step S14. In step S14, it is determined whether or not the scan end position set in advance is reached, and if not, the process returns to step S5 to continue the AF scan. Whereas if the scan end position is reached, the process proceeds to step S15 where it is determined that the focus detection is failed, and the focus lens group 3 is moved to a predetermined position. The predetermined position may be set using the position where the probability that the subject exists is high or the distance to the subject estimated from the size of the face of a person. Next in step S16, an out-of-focus frame is displayed in the image display area of the LCD 10, and then the process proceeds to step S13. The out-of-focus frame is a frame displayed at an area where the subject exists or at a predetermined area in the image area in an out-of-focus state, and displayed in a color (for example, yellow) different from a color of an in-focus frame so that the photographer can easily know the out-of-focus state.

In a case where the focus evaluation value decreases by the predetermined amount or more from the previously obtained value, it is determined in step S8 that the peak of the focus evaluation values is detected, and the process proceeds to step S9. In step S9, interpolation calculation and so forth is performed in accordance with the relationship between the positions of the focus lens group 3 and the focus evaluation values to attain the position of the focus lens group 3 at which the focus evaluation value is maximized. In addition, reliability of a curve of the focus evaluation value around the maximum value is evaluated. In this reliability evaluation, it is determined whether the maximum value of the focus evaluation value is resulted from the optical image of the subject being properly focused on the image sensor, or from external noise.

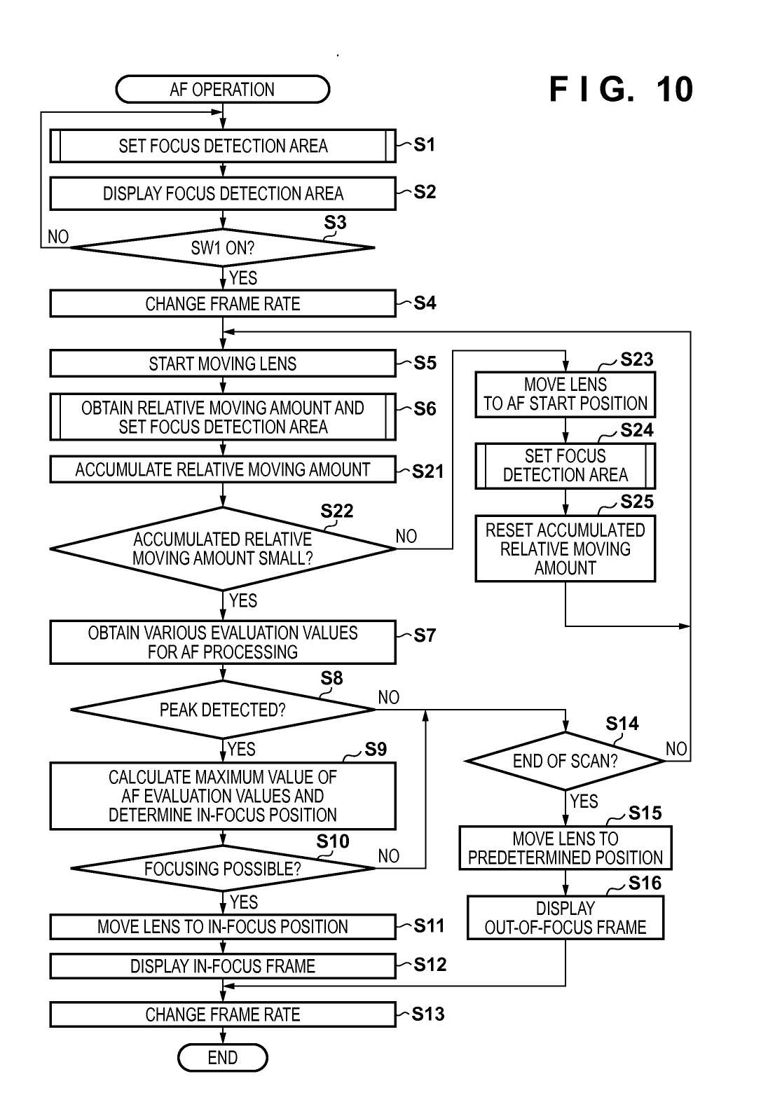

As the detailed method of determining the in-focus position, the method described in the Japanese Patent Laid-Open No. 2010-078810 with reference to FIGS. 10 to 13 may be used. In summary, it is possible to determine whether or not the in-focus position is detected by determining whether or not a graph of the focus evaluation values showing the focus state forms a concave down shape from the difference between the maximum and minimum values of the focus evaluation values, the length of a slope whose inclination is a predetermined value (SlopeThr) or more, and the inclination of the slope.

Next in step S10, whether or not the detected maximum value of the focus evaluation values indicates an in-focus position with high reliability is determined. If the reliability of the focus evaluation value is low, the process proceeds to step S14 and the focusing processing is continued. Whereas, if the reliability of the focus evaluation value is high and the maximum value is appropriate as the in-focus position, the process proceeds to step S11, and the focus lens group 3 is driven to the calculated in-focus position. Then, the process proceeds to step S12 where the in-focus frame is displayed in the image display area of the LCD 10. The in-focus frame is a frame showing which area in an image area is in focus. For example, if a face is in focus, then frame is displayed in a face area. Further, the focus frame is displayed in a color (for example, green) indicating the in-focus state so that the photographer easily recognizes that the image is in focus.

After displaying the in-focus frame, the process proceeds to step S13 where the frame rate is changed from the second time interval to the first time interval. This process is performed because energy consumption is too high to continue driving the image sensor 5 at the second time interval which is shorter than the first interval after the in-focus state is reached. After the frame rate is changed, the AF operation is ended.

It should be noted that, in the above example in step S2 of FIG. 3, it is described that the focus detection area is displayed based on the position information of the subject obtained in advance, and not updated during the AF scan. This is because if a time taken to perform focusing processing is sufficiently short, the photographer will not feel unnatural if the display position of the focus detection area is not updated. However, in a case where the subject moves at high speed, the focus detection area is moved on the basis of the relative moving amount information of the subject during the AF scan as described above. At that time, the display of the focus detection area may be updated. By doing so, although the processing contents increase, it is possible to display the focus detection area following the movement of the subject in real time.

Next, a focus detection area setting processing performed in step S1 of FIG. 3 will be explained with reference to FIG. 5. Here, various detection areas are set for the situation shown in FIGS. 4A and 4B.

First, in step S101, the position information acquisition area 301 from which information such as the position of the subject is obtained using the subject detection circuit 30 is set. Here, in a case where no previous subject position information exists, the whole area of the image frame 500 is set as the position information acquisition area 301. If the previous subject position information exists and the change in the subject is small, the position information acquisition area 301 is set in consideration of the previous subject position information. It should be noted that information obtained by accumulating the relative moving amount (described later) may be used as the previous subject position information. Further, in this embodiment, the focus detection area 303 is updated based on the relative moving amount during AF processing, however, the position information acquisition area 301 may be set for the next frame using an accumulated relative moving amount calculated by accumulating the relative moving amount each time it is detected. In a case where both the subject position information and the accumulated relative moving amount are used, the accumulated relative moving amount is reset each time the subject position information is obtained.

Next in step S102, detected subject information (number, position, size, and inclination) is obtained from the subject detection circuit 30, and the process proceeds to step S103. In step S103, a variable i for counting the number of face/faces is initialized to 0, and then the process proceeds to step S104. In step S104, the size of the focus detection area 303 with respect to the detected subject detection area 304 is calculated.

In general, in a human face, the contrast is high in black portions, such as hair, eye blow, and eyes, and in shaded portions caused by opening of nose and mouth, and the focus evaluation values are large in those portions. Therefore, it is desirable to include such high contrast portions in the focus detection area 303.

Further, in a case where the contrast between a face portion and the background is high, the focus evaluation value at contour of the face becomes large. However, in a case where the focus detection area 303 includes the contour of the face, there is a possibility that conflict that the in-focus states are detected both at a near distance and a far distance occurs due to the effect of the background image. As the conflict that occurs when the focus detection area 303 includes both the face and the background image around the face, a case where the background image at a distance is focused and a case where a portion around the ear which forms the contour of the face is focused instead of a portion around the eyes of a human that a photographer commonly intends to focus on may be considered.

Accordingly, by setting an area so as not to include the contour of the face in the focus detection area 303, it is possible to reduce an effect of the contour of the face to the focus evaluation value in a case where the face moves during the AF scan. However, in a case where the size of the face is smaller than a predetermined size, the present invention is not limited to this. If the face is small, it is assumed that the image sensing distance is relatively far, and the depth of focus will be deepened. Further, there is an anxiety that an S/N ratio of the signals within the focus detection area may deteriorate. In consideration of these situations, the focus detection area 303 may be set so as to include the contour of the face as appropriate.

After setting the focus detection area 303 within the i-th face in accordance with the information on the position, size, and inclination of the face as described above, i is increased by 1 in step S105, and then the process proceeds to step S106. In step S106, whether the variable i is equal to the number of the detected face. If not equal, the process returns to step S104, whereas if equal, the process advances to step S107.

In step S107, a face that the photographer aims at as a main subject is predicted based on the position and size of each detected face and a priority of each detected face is set. Here, it is assumed that a face located at a position nearest to the center of an image area as well as having the size greater than a predetermined size is the main face, and other detected face/faces are assumed as sub-face/faces. Namely, the face selected as a main subject from the plurality of detected faces is the main face. The focus detection area 303 of the main face is used for determining an in-focus position. Whereas the focus detection area 303 of each sub-face is not used for determining an in-focus position, but it is checked whether or not the peak position of the focus evaluation values in the main area of each sub-face and the in-focus position is within a predetermined range, and if so, the in-focus frame is displayed for the sub-face area in the image area. Further, in a case where it is determined that the main face cannot be focused when detecting the in-focus position after the AF scan, the sub-face/faces are used for determining an in-focus position. Therefore, a priority of each sub-face is also determined on the basis of the distance from the center of the image area and the size of each sub-face.

In step S108, the moving amount information acquisition area 302 is set. The moving amount information acquisition area 302 is set so as to include the focus detection area 303 of the main face. As described above, the moving amount information acquisition area 302 is an area where a moving amount of the subject is detected during the AF scan. Accordingly, it is desirable to set the moving amount information acquisition area 302 so that the subject (main face) does not frame out from the moving amount information acquisition area 302 during the AF scan based on the moving state (e.g., velocity and acceleration) of an optical image of the subject on the image sensor 5. The moving state of the optical image of the subject on the image sensor 5 may be predicted using information on the movement of the subject and camera shake. When step S108 is finished, the focus detection area setting processing is ended.

Next, processing of the relative moving amount acquisition and the focus detection area setting performed in step S6 of FIG. 3 will be explained with reference to the flowchart of FIG. 6. Here, the relative moving amount of the subject during the AF scan is detected using the moving amount information acquisition area 302 set in S1, and the focus detection area 303 is updated based on the detected moving amount.

In step S601, the line-peak evaluation values in the moving amount information acquisition area 302 are calculated using the signal output from the image sensor 5 and recorded. Next in step S602, whether or not line-peak evaluation values of a plurality of frames including line-peak evaluation values of a previous frame are stored is determined. If not, this sub-routine is ended.

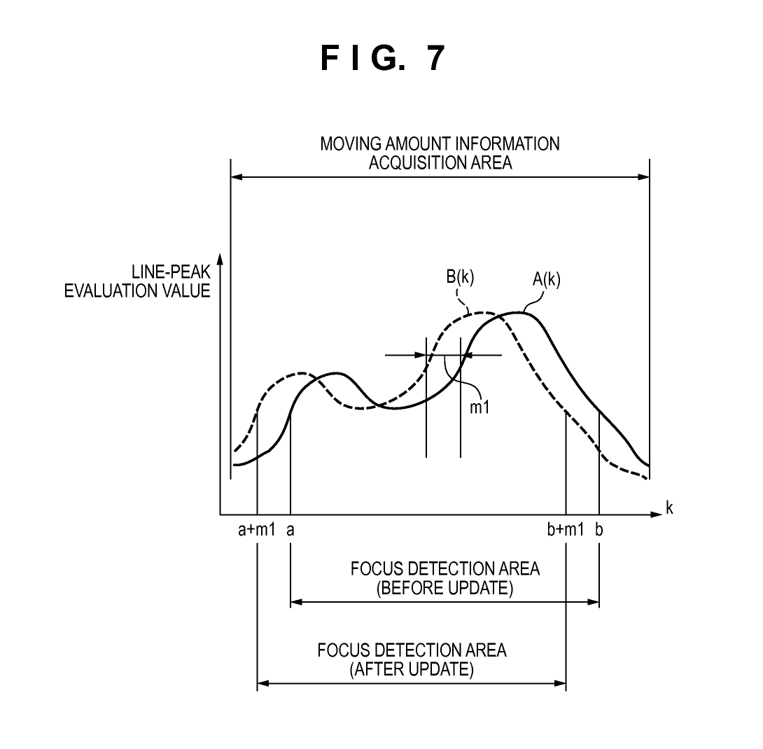

In contrast, in a case where the line-peak evaluation values of a plurality of frames including the line-peak evaluation values of the previous frame are stored, the process proceeds to step S603 where the relative moving amount is obtained. The relative moving amount is obtained by calculating an image shift amount of two sets of the line-peak evaluation values by the CPU 15. FIG. 7 shows an example of the line-peak evaluation values. In FIG. 7, each line peak value constituting the line-peak evaluation values obtained from the signal of the n-th frame is shown by A(k), and each line peak value constituting the line-peak evaluation values obtained from the signal of the (n+1)-th frame is shown by B(k). “k” denotes a row number in the vertical direction within the moving amount information acquisition area 302.

Upon calculating the image shift amount, the two line-peak evaluation values (A(k) and B(k)) are shifted with respect to each other while correlation calculation is performed to obtain a correlation amount COR by using the function shown below.

$$COR ( {s}_{1} ) = {\sum }_{k ∈ W} \vert A ( k ) - B ( k - {s}_{1} ) \vert , \\ {s}_{1} ∈ Γ1 \qquad ( 1 )$$

In the function (1), s₁ denotes a shift amount and Γ1 denotes a shift range of the shift amount s₁. By shifting by the shift amount s₁, the line-peak value A(k) of the k-th row is corresponded to the line-peak value B(k−s₁) of the (k−s₁)-th row, and the differences between the corresponded line-peak values are calculated for the respective rows, thereby generating shifted difference signals. Then, the absolute values of the generated shifted difference signals are calculated and added within a range W corresponding to the moving amount information acquisition area 302, thus the correction amount COR (s₁) is calculated.

Further, a shift amount of a real number whose correlation amount is minimum is calculated by sub-pixel operation, and an image shift amount m1 as shown in FIG. 7 is obtained. The image shift amount m1 calculated here corresponds to the relative moving amount of the subject in the vertical direction. Note that in a case where the image capturing apparatus has a configuration capable of calculating the evaluation values for AF processing in the vertical direction, a relative moving amount m2 in the horizontal direction is calculated in the similar manner.

In the above example, the line-peak evaluation values calculated from the luminance signal Y is used, however, the line-peak evaluation values may be calculated from RGB (red, green and blue) signals from the image sensor covered with a Bayer color filter. In this case, there are rows covered with R and G filters and rows covered with G and B filters, the line-peak evaluation values are calculated separately for the even-numbered rows and the odd-numbered rows. In this manner, it is possible to obtain an image shift amount in the similar manner as described above.

Next in step S604, the CPU 15 calculates reliability of the pair of line-peak evaluation values (A(k) and B(k)) used for the calculation of the image shift amount. As a method for calculating the reliability, a method used in phase difference focus detection may be used. For example, S level as disclosed in the Japanese Patent Laid-Open No. 2007-52072 is used, and reliability of the calculated image shift amount can be measured from the magnitude of the S level. In this embodiment, the image shift amount is calculated by using an output signal from the image sensor 5 obtained while shifting the focus lens group 3. Accordingly, the relative moving amount is calculated using a pair of line-peak evaluation values under different defocus states. Since it is difficult to obtain an image shift amount with high reliability from a pair of line-peak evaluation values obtained under greatly defocused state, the reliability is determined using the S level.

Next in step S605, whether or not the obtained relative moving amount (image shift amount) is reliable is determined. If not, this sub-routine is ended; whereas if yes, the process proceeds to step S606 where the focus detection area 303 is updated by shifting the position of the focus detection area 303 in accordance with the obtained relative moving amount. The update of the focus detection area 303 performed here determines an integration range of the line-peak values in the vertical direction and a range for calculating line-peak values in the horizontal direction upon calculating the focus evaluation value (the all-line integrated evaluation value) within the focus detection area 303.

FIG. 7 collectively shows the moving amount information acquisition area 302 from which the line-peak evaluation values A(k), B(k) are obtained, the focus detection area 303 before and after the update. In the moving amount information acquisition area 302, assume that the focus evaluation value calculated for the focus detection area 303 before the update is an integral value of the line-peak values from the a-th row to the b-th row, and the focus detection area 303 after the update ranges from the (a+m1)-th row to the (b+m1)-th row. Namely, after the update, the focus evaluation value is calculated by integrating the line-peak values from the (a+m1)-th row to the (b+m1)-th row.

Further, in a case where the relative moving amount m2 in the horizontal direction is calculated, the horizontal range of the focus detection area 303 is updated. Assume that the focus detection area 303 before the update ranges from the c-th column to the d-th column; then the focus detection area 303 after the update ranges from the (c+m2)-th column to the (d+m2) column, and the line-peak values are integrated over this range to obtain the focus evaluation value.

Nest in step S607, the moving amount information acquisition area 302 is updated using the relative moving amounts m1 and m2 in the vertical and horizontal directions so that the area 302 is used for calculating various evaluation values for AF processing from the signal obtained from the image sensor 5 next time. This is aimed at preventing feature information within the moving amount information acquisition area 302 from being out of the area 302.

Note that updating of the moving amount information acquisition area 302 performed in step S607 may be omitted depending on the detected moving amount. Namely, if a detected moving amount is smaller than a predetermined value, then the moving amount information acquisition area 302 may not be updated. Further, updating of the moving amount information acquisition area 302 may be performed using accumulated values of the relative moving amounts m1 and m2 in the vertical and horizontal direction. In a case where the accumulated relative moving amounts are to be used, it is preferable that the relative moving amounts m1 and m2 that are to be used for setting the focus detection area 303 have information with a higher resolution. For example, when it is obtained that the image shift amount is 3.2 pixels, the image shift amount m1 of the focus detection area 303 may be 3 by rounding off 3.2 to the nearest whole number. By contrast, when calculating the accumulated relative moving amount, if each image shift amount m1 is rounded off, error is also accumulated. Thus, a more precise accumulated relative moving amount can be obtained by using the image shift amount m1=3.2 pixels.

After the step S607, the processing of the relative moving amount acquisition and focus detection area setting is ended, and the process returns to step S7.

Note that a contrast detection type focus detection method is used in the first embodiment, however, the focus detection method is not limited thereto. For example, a phase difference type focus detection method may be used by arranging pixels for focus detection in the image sensor, and a technique disclosed in Japanese Patent Laid-Open No. 2012-63396 may be used. In such case, an image shift amount corresponding to a defocus amount is calculated by the phase difference detection in step S7 of FIG. 3, thereafter the process directly proceeds to step S10.

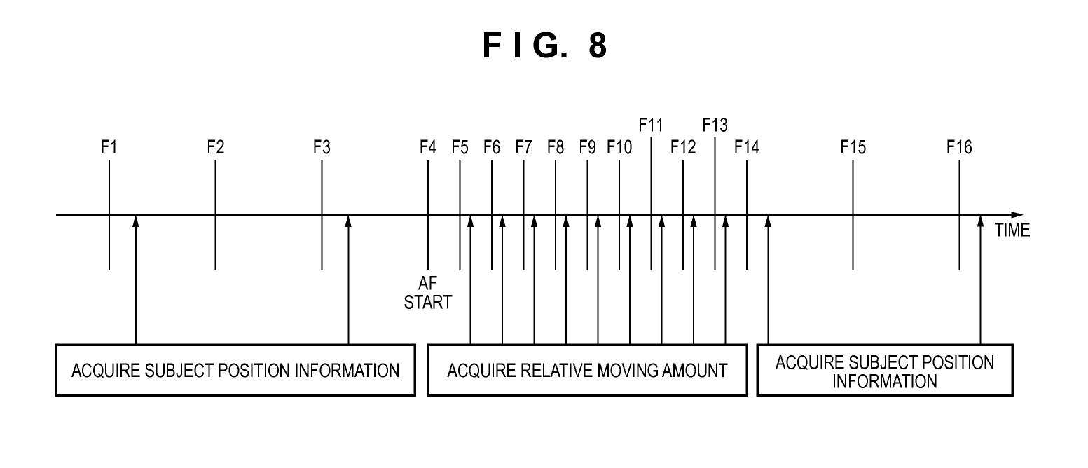

Next, an example of timing for obtaining the position information and relative moving amount of the subject in a case where the AF operation described with reference to FIG. 3 is performed will be explained with reference to FIG. 8. In FIG. 8, the abscissa indicates time, and F1 to F16 indicate time of obtaining an output signal from the image sensor 5. From time F1 to F4, the output signal is obtained from the image sensor 5 at the first time interval. When the AF operation starts at time F4, the obtaining interval is changed to the second time interval that is shorter than the first time interval, and the output signal is obtained from the image sensor 5 at the second time interval. When the AF operation ends at time F14, the obtaining interval is changed to the first time interval.

In the first embodiment, during the first time interval is used, the subject position information is obtained using information within the position information acquisition area 301 set in advance. As the acquisition method of the subject position information, calculation of a motion vector using a known face detection and color information, and a pattern matching, and so forth may be used. In other words, when obtaining the subject position information, since the amount of information, such as position, size, inclination, person authentication, and so on, to be detected is large, a calculation amount required for the detection becomes large, which requires time. Therefore, FIG. 8 shows a case where the subject position information is updated every two first time intervals.

On the other hand, in a case of obtaining the output signal from the image sensor 5 at the second time interval, the relative moving amount is obtained for every frame. Characteristics of obtaining the relative moving amount according to the first embodiment are that an area smaller than the position information acquisition area 301 is set as the moving amount information acquisition area 302 and the calculation content is simplified, thereby calculation of information can be performed at higher speed.

In the first embodiment, when image signals of a plurality of frames are obtained after the AF operation started, the relative moving amount is calculated (at time F5 and after), and the focus detection area 303 is updated with the subject position information obtained between time F3 and F4 being as an initial value. In a case where the focus detection is performed by using data obtained in time sequence, it is desirable that the data corresponds to signals obtained from the same area of the subject. The area from which the signals are obtained affects the precision of the peak position detection in a case of the contrast detection type focus detection method, and affects the precision for predicting movement of the subject in a case of the phase difference focus detection method. In this manner, according to the first embodiment, it is possible to perform focus adjustment at high speed by switching to a higher frame rate during focus detection processing, and to make the focus detection area 303 follow the movement of the subject at high speed, thereby realizing high precise focus detection.

After the AF operation is finished, the time interval for acquiring an output signal is changed to the first time interval at time F14, and acquisition of the subject position information is performed again.

In the first embodiment as described above, the detection of the relative moving amount of the subject is performed using change of the line-peak evaluation values (image shift amount) in time, however, the detection method is not limited to this. For example, line-peak values of the luminance signal Y may be used. Further, for example, a central row or column of the focus detection area may be selected, and an image shift amount may be calculated using a luminance signal of the selected row or column. However, an advantage of detecting the relative moving amount using the line-peak evaluation values is as described above.

Further, the detection of the relative moving amount of the subject may be performed using different method depending on the direction of detection. For example, in a case where AF processing is performed only in the horizontal direction, the relative moving amount of the subject in the vertical direction may be detected using the line-peak evaluation values that is calculated in the process of calculating the focus evaluation value in the horizontal direction, and the relative moving amount of the subject in the horizontal direction may be detected using the luminance signal. In this manner, it is possible to detect the relative moving amount of the object both in the horizontal and vertical directions while reducing the computation load.

Further, when focus detection pixels are arranged in the image sensor 5 and it is possible to perform phase difference focus detection using those focus detection pixels, the relative moving amount of the present invention may be performed using the output signal of the focus detection pixels. In that case, between a pair of focus detection pixels which receive light fluxes that have passed through different exit pupil areas of the imaging optical system, output signal of one of the focus detection pixels may be used to calculate the line-peak evaluation values or obtain luminance signal to calculate the relative moving amount.

Further, in the first embodiment, the relative moving amount is obtained each time an output signal is acquired from the image sensor 5 in step S6 of FIG. 3, however, the acquisition of the relative moving amount may be omitted. For example, in a case where a defocused amount is expected to be large, such as in a case where a focus evaluation value obtained in advance is small, the focus detection precision will not be affected by omitting calculation of the line-peak evaluation values or of the relative moving amount. By doing so, it is possible to reduce a computation load during the focus control.

According to the first embodiment as described above, it is possible to perform position detection of the subject in a frame at high precision regardless of frame rate. Accordingly, it is possible to improve the focus detection precision regardless of focus detection methods.

Note that a case where the image capturing apparatus as described above in the first embodiment performs the focus control by driving the focus lens group 3, however, the image capturing apparatus may have a configuration such that the focus control is performed by driving the image sensor 5 in the optical axis direction.

<Modification>

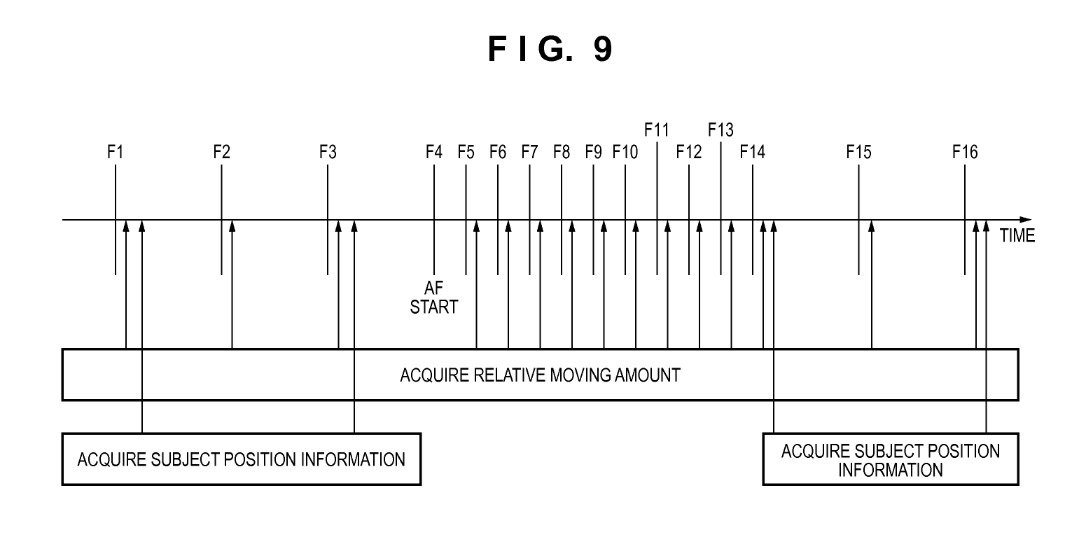

FIG. 8 shows an example of timing for realizing the AF operation shown in FIG. 3 in the first embodiment, whereas in this modification, timing will be explained with reference to FIG. 9. Similarly to FIG. 8, FIG. 9 shows an example of timing for acquiring the subject position information and the relative moving amount in a case where the AF operation shown in FIG. 3 is performed. In FIG. 9, the abscissa indicates time, and F1 to F16 indicate time of obtaining output signal from the image sensor 5. From time F1 to F4, the focus detection data is obtained at the first time interval. When the AF operation starts at time F4, the obtaining interval is changed to the second time interval that is shorter than the first time interval, and focus detection data is acquired at the second time interval. When the AF operation ends at time F14, the obtaining interval is changed to the first time interval, as shown in FIG. 9.

The difference between FIGS. 9 and 8 is that in FIG. 9, the relative moving amount is calculated during acquiring the focus detection data at the first time interval. As described above, since it takes time to acquire subject position information, the position information is updated every two first time intervals. On the other hand, since it is possible to obtain the relative moving amount at higher speed, the relative moving amount is acquired in parallel with acquiring the position information in the example shown in FIG. 9, the subject position information is interpolated, thereby improving the precision of detecting the position of the subject. In this manner, although a computation load increases because the relative moving amount is acquired during operating at the first time interval, it is possible to obtain high precise subject position information using the relative moving amount in a case where AF start timing is in between time F2 and time F3, for example, and there is some time since position information is last obtained.

### Second Embodiment

Next, a second embodiment of the present invention will be described with reference to FIG. 10. The processing in the AF operation in the second embodiment is different from that explained in the first embodiment with reference to FIG. 3. Major difference between the first embodiment and the second embodiment is that, each time a relative moving amount is calculated, an accumulated relative moving amount is calculated and the magnitude of the accumulated relative moving amount is checked. If the accumulated relative moving amount is large, there is a possibility that detected position information of the subject is not correct or calculation precision of the relative moving amount is not good. Accordingly, in such case, focus adjustment is performed again. By doing so, it is possible to avoid focus detection in a case where decrease in the focus detection precision is anticipated at the time of updating the focus detection area using the relative moving amount. As a result, it is possible to improve the focus detection precision eventually.

Note that the configuration of the image capturing apparatus and the processes except the above difference are the same as those explained in the first embodiment, therefore, the explanation of them are omitted. The AF operation in the second embodiment will be explained below with reference to FIG. 10. In FIG. 10, the processes which are the same as those in FIG. 3 are given the same step numbers, and explanation of them are omitted.

In step S21 in FIG. 10, a relative moving amount calculated in step S6 is accumulated, and in step S22, whether or not the accumulated moving amount is smaller than a predetermined value is determined. If the accumulated moving amount is smaller than a predetermined value, the process proceeds to step S7.

If the accumulated relative moving amount is equal to or larger than the predetermined value, the process advances to step S23, where the focus lens group 3 is moved to the AF start position in order to restart the focus adjustment. For example, the focus lens group 3 is moved to the AF start position where the subject at the infinite distance is focused.

Next in step S24, the focus detection area 303 is set again. The process performed here is the same as that performed in step S1. Thereafter, the accumulated relative moving amount is reset in step S25, and the process moves to step S5. In this manner, in a case where the accumulated relative moving amount is large, it is possible to set the focus detection area 303 again after newly obtaining subject position information. This is because a detection error is produced each time a relative moving amount is calculated, and the accumulation of such error may result in performing focus detection on an area different from an area including a subject that a photographer wants to focus on. Another purpose of the above process is to prevent an area that includes a main feature amount for calculating the focus evaluation value from moving out from the moving amount information acquisition area 302 and the focus detection area 303 when the moving amount of the subject is large.

With the reasons as set forth above, whether or not to perform the focus adjustment again may be determined based on the magnitude of the number of times the relative moving amount is calculated and based on reliability determination at the time of calculating the relative moving amount, in addition to the magnitude of the accumulated moving amount.

It should be noted that it is desirable that the accumulated relative moving amount has information with high resolution with respect to the relative moving amounts m1 and m2 used for setting the focus detection area 303 with the reasons as described above in the first embodiment.

According to the second embodiment as described above, it is possible to perform high precise focus adjustment without being affected by an error at the time of calculating the relative moving amount and the movement of the subject.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-025925, filed on Feb. 13, 2014, and No. 2014-027862, filed on Feb. 17, 2014, which are hereby incorporated by reference herein in their entirety.

What is claimed is:

1. A focus control apparatus comprising:
a setting unit configured to set a focus detection area in an area where a subject exists based on an image signal output from an image sensor that detects a light flux which enters via an imaging optical system;
a first subject following unit configured to follow the subject by performing subject detection;
a second subject following unit configured to follow the subject based on a contrast evaluation value generated from the image signal output from the image sensor; and
a control unit configured to control a frame rate for following the subject by the second subject following unit to be faster than that by the first subject following unit.

2. A focus control apparatus comprising:
a setting unit configured to set a focus detection area in an area where a subject exists based on an image signal output from an image sensor that detects a light flux which enters via an imaging optical system;
a subject following unit configured to follow the subject based on a contrast evaluation value generated from the image signal output from the image sensor; and
a calculation unit configured to calculate information on a moving amount of the subject acquired by calculating correlation between two contrast evaluation values generated from two image signals output from the same focus detection area of the image sensor at different timings.

3. The focus control apparatus according to claim 2, wherein the calculation unit comprises:
an acquisition unit configured to acquire a unit evaluation value group by acquiring a plurality of unit evaluation values in a first direction that is orthogonal to a predetermined second direction for each of image signals output from the same focus detection area at different timings, wherein each unit evaluation value indicates a feature amount of the contrast evaluation value in the second direction;
a correlation calculation unit configured to calculate correlation between the plurality of unit evaluation value groups acquired by the acquisition unit from the same focus detection area at the different timings; and
a moving amount calculation unit configured to calculate the moving amount using the correlation calculated by the correlation calculation unit.

4. The focus control apparatus according to claim 3, wherein the unit evaluation value is a line-peak evaluation value in the second direction.

5. A control method for a focus control apparatus comprising:
a setting step of setting a focus detection area in an area where a subject exists based on an image signal output from an image sensor that detects a light flux which enters via an imaging optical system;
a first subject following step of following the subject by performing subject detection;
a second subject following step of following the subject based on a contrast evaluation value generated from the image signal output from the image sensor; and
a control step of controlling a frame rate for following the subject by the second subject following unit to be faster than that by the first subject following unit.

6. A control method for a focus control apparatus comprising:
a setting step of setting a focus detection area in an area where a subject exists based on an image signal output from an image sensor that detects a light flux which enters via an imaging optical system;
a subject following step of following the subject based on a contrast evaluation value generated from the image signal output from the image sensor; and
a calculation step of calculating information on a moving amount of the subject acquired by calculating correlation between two contrast evaluation values generated from two image signals output from the same focus detection area of the image sensor at different timings.

7. The control method according to claim 6, wherein the calculation step comprises:
an acquisition step of acquiring a unit evaluation value group by acquiring a plurality of unit evaluation values in a first direction that is orthogonal to a predetermined second direction for each of image signals output from the same focus detection area at different timings, wherein each unit evaluation value indicates a feature amount of the contrast evaluation value in the second direction;
a correlation calculation step of calculating correlation between the plurality of unit evaluation value groups acquired in the acquisition step from the same focus detection area at the different timings; and
a moving amount calculation step of calculating the moving amount using the correlation calculated in the correlation calculation step.

8. The control method according to claim 7, wherein the unit evaluation value is a line-peak evaluation value in the second direction.

9. A non-transitory readable storage medium having stored thereon a program which is executable by an information processing apparatus, the program having a program code for realizing the control method according to claim 5.

10. A non-transitory readable storage medium having stored thereon a program which is executable by an information processing apparatus, the program having a program code for realizing the control method according to claim 6.
